(19) United States
(12) Patent Application Publication
(10) Pub. No.: US 2024/0420085 A1
(43) Pub. Date: Dec. 19, 2024

(54) PERFORMING AUTOMATED PROJECT ADJUSTMENT

(71) Applicant: International Business Machines Corporation, Armonk, NY (US)

(72) Inventors: Jeremy R. Fox, Georgetown, TX (US); Zachary A. Silverstein, Georgetown, TX (US); Melanie Dauber, Oceanside, NY (US); Jacob Ryan Jepperson, St. Paul, MN (US); Spencer Thomas Reynolds, Austin, TX (US); Logan Bailey, Atlanta, GA (US)

(21) Appl. No.: 18/336,189

(22) Filed: Jun. 16, 2023

(51) Int. Cl. G06Q 10/10; G10L 15/18; G10L 15/22

(52) U.S. Cl. CPC G06Q 10/103; G10L 15/1815; G10L 15/22

(57) ABSTRACT

Disclosed embodiments provide for a computer-implemented method. The method includes obtaining text data pertaining to a project. Natural language processing (NLP) is performed on the obtained text data, which includes detecting one or more entities. Sentiment analysis associated with the detected one or more entities is performed. An automated project adjustment is performed based on the performed sentiment analysis and the detected one or more entities.

### BACKGROUND

The present invention relates generally to project adjustment, and more particularly, to performing automated project adjustment.

Project management is a complex discipline that involves coordinating resources, contributors, and tasks to achieve specific goals within defined constraints (e.g., deadlines, scopes, budgets, available resources, etc.). While the specific challenges can vary depending on a nature and an industry of a project, many projects encounter similar types of challenges. For example, resource management and navigation of complex technical and administrative tasks effectively are crucial to project success. Associated project challenges can include limited availability of necessary resources; conflicts between contemporaneous projects competing for the same resources; ensuring proper allocation of resources; managing diverse contributors with different interests, expectations, and levels of involvement (particularly when dealing with conflicting requirements or limited communication channels); team coordination; accounting for contributor communications; and quality control all while remaining on schedule. However, projects are susceptible to various risks, including technical, financial, operational, and external factors. Projects frequently encounter delays for a variety of different reasons (e.g., unexpected obstacles, contributor issues, scope changes, resource constraints, budget constraints, etc.).

### SUMMARY

In an exemplary embodiment of the present invention, a computer-implemented method is provided. The method includes obtaining text data pertaining to a project. Natural language processing (NLP) is performed on the text data, which includes detecting at least one entity. Sentiment analysis associated with the at least one entity is performed. An automated project adjustment is performed based on the sentiment analysis and the detected at least one entity.

In another exemplary embodiment of the present invention, a computer system is provided. The computer system includes at least one computer processor, at least one computer-readable storage media, and program instructions stored on the at least one of the computer-readable storage media for execution by at least one of the at least one processor capable of performing a method. The method includes obtaining text data pertaining to a project. Natural language processing (NLP) is performed on the text data, which includes detecting at least one entity. Sentiment analysis associated with the at least one entity is performed. An automated project adjustment is performed based on the sentiment analysis and the detected at least one entity.

In another exemplary embodiment of the present invention, a computer program product is provided. The computer program product includes at least one computer-readable storage media and program instructions stored on the at least one non-transitory computer-readable storage media capable of performing a method. The method includes obtaining text data pertaining to a project. Natural language processing (NLP) is performed on the text data, which includes detecting at least one entity. Sentiment analysis associated with the at least one entity is performed. An automated project adjustment is performed based on the sentiment analysis and the detected at least one entity.

### BRIEF DESCRIPTION OF THE DRAWINGS

FIG. 1 illustrates a computing environment in accordance with an exemplary embodiment of the present invention.

FIG. 2 illustrates an ecosystem in accordance with an exemplary embodiment of the present invention.

FIG. 3 illustrates a flowchart indicating process steps, according to an exemplary embodiment of the present invention.

FIG. 4 illustrates a flowchart indicating process steps, according to an exemplary embodiment of the present invention.

FIG. 5 illustrates a user interface, according to an exemplary embodiment of the present invention.

FIG. 6 illustrates text data pertaining to a project, analyzed in accordance with an exemplary embodiment of the present invention.

FIG. 7 illustrates another exemplary user interface according to an exemplary embodiment of the present invention.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION

Proactively analyzing and managing risk in project management offers several benefits that can help ensure a project succeeds. One such benefit is early issue identification. By anticipating and identifying issues early on, preventative measures and strategies can be employed to mitigate or resolve the underlying issues. Another benefit is risk mitigation. Identifying potential risks and analyzing their impact and probability can serve to minimize the likelihood of risks occurring and/or mitigate their impact if they do materialize. Yet another benefit is increased efficiency and productivity. By taking a proactive approach, resource allocation and task management can be optimized, serving to identify and eliminate potential roadblocks, streamline processes, and identify opportunities for improvement. This proactive approach can lead to improved efficiency and productivity throughout the project lifecycle, which can increase the likelihood of a successful project.

Disclosed embodiments provide for performing automated project adjustment. Text data can be obtained pertaining to a project. The text data can include emails, instant messages, white papers, notes, meeting transcripts, and/or other text information. Natural language processing (NLP) can be performed on the obtained text data, such as using a machine learning system. The natural language processing can include performing an entity detection process to obtain one or more entities (e.g., predetermined keywords, subjects, topics, etc.) within the obtained text. The natural language processing can include performing a sentiment analysis. The sentiment analysis can be associated with the one or more detected entities. Based on the sentiment and the detected one or more entities, an automated project adjustment can be performed, such as adjusting deadlines, budgets, timelines, objectives, contributors, roles, etc. associated with the project and/or adjusting various resources allocated to the project. In this way, the project may have an increased likelihood of timely completion and/or optimization.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to exemplary embodiments of the present invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

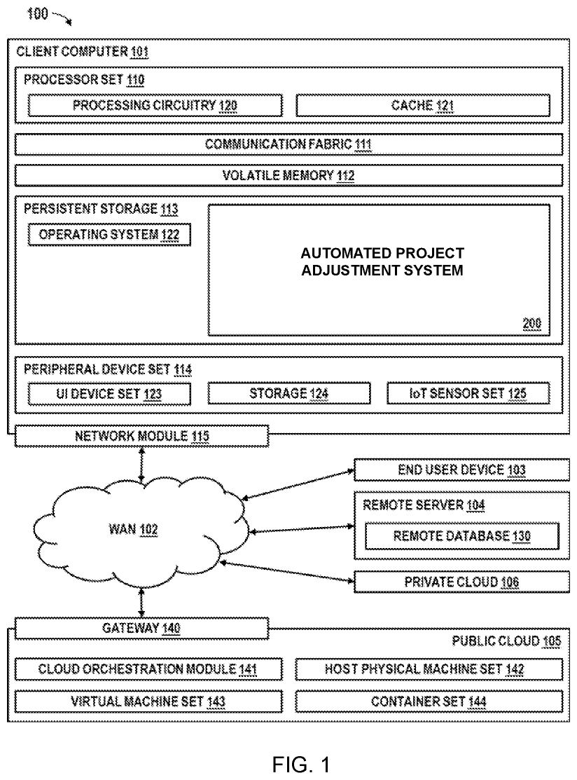

FIG. 1 illustrates an exemplary computing environment 100 in accordance with an exemplary embodiment of the present invention. Computing environment 100 contains an example of an environment for the execution of at least some of the computer code involved in performing the inventive methods, such as an automated project adjustment system block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

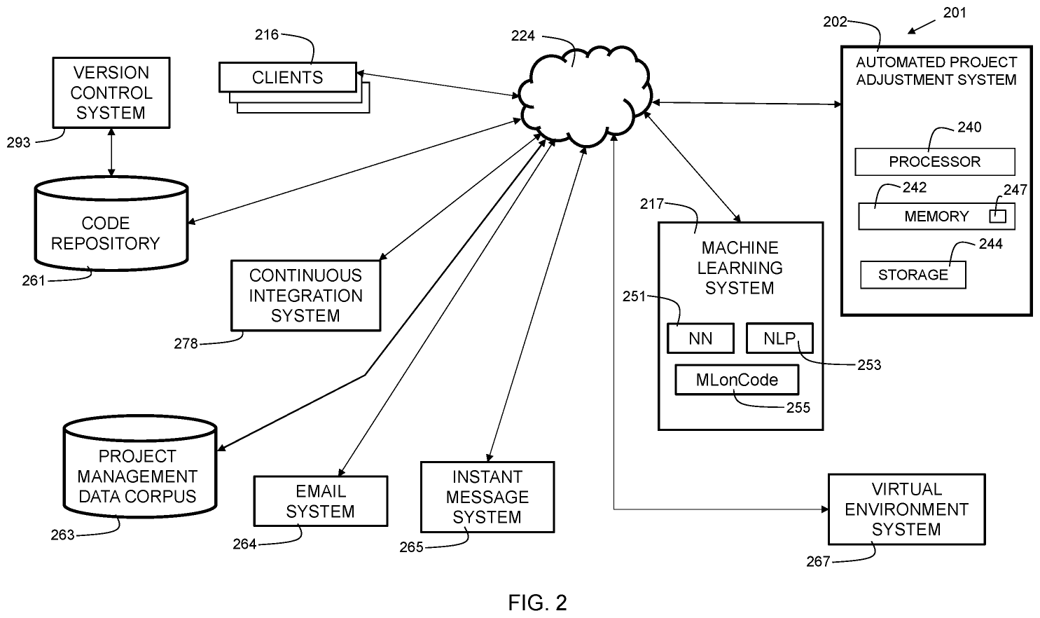

FIG. 2 illustrates an ecosystem 201 in accordance with an exemplary embodiment of the present invention. Automated Project Adjustment System (APAS) 202 comprises a processor 240, a memory 242 coupled to the processor 240, and storage 244. APAS 202 is an electronic computation device (e.g., computer system). The memory 242 contains program instructions 247, that when executed by the processor 240, perform processes, techniques, and implementations of exemplary embodiments of the present invention. Memory 242 can include dynamic random-access memory (DRAM), static random-access memory (SRAM), magnetic storage, and/or a read only memory such as flash, EEPROM, optical storage, or other suitable memory, and should not be construed as being a transitory signal per se. In some embodiments, storage 244 may include one or more magnetic storage devices such as hard disk drives (HDDs). Storage 244 may additionally include one or more solid state drives (SSDs). The APAS 202 is configured to interact with other elements of ecosystem 201. APAS 202 is connected to network 224, which is the Internet, a wide area network, a local area network, and/or other suitable network.

Ecosystem 201 may include one or more client devices, indicated as 216. Client device 216 can include a laptop computer, desktop computer, tablet computer, or other suitable computing device. Client device 216 may be used to interact with APAS 202 to enable end-users to receive project adjustments and/or project adjustment alerts. Additionally, client device 216 may be used to configure features in the APAS 202, including features such as establishing sources of text data pertaining to a project, such as email, instant messaging data, as well as project data from project management software applications.

Ecosystem 201 may include machine learning system 217. The machine learning system 217 can include a neural network (NN) 251, and/or a natural language processing (NLP) module 253. In some embodiments, the machine learning system 217 may include a Support Vector Machine (SVM), Decision Tree, Recurrent Neural Network (RNN), Long Short Term Memory Network (LSTM), Radial Basis Function Network (RBFN), Multilayer Perceptron (MLP), and/or other suitable neural network type. In embodiments, the machine learning system 217 is trained using supervised learning techniques.

The NLP module 253 may include software and/or hardware for performing Natural Language Processing (NLP). NLP is a subfield of artificial intelligence that involves teaching computers to understand, interpret, and/or generate human language. NLP works by breaking down human language into its constituent parts and analyzing them using various algorithms and techniques. In one or more embodiments, the NLP process includes tokenization, which can include breaking down a piece of text into individual words or phrases. The NLP process can further include Part-of-speech (POS) tagging. POS tagging can include analyzing each token and assigning it a part of speech, such as noun, verb, adjective, or adverb. The NLP process can further include parsing, which involves analyzing the syntactic structure of a sentence to identify the relationships between the words and phrases. The process can include entity detection, which involves identifying and categorizing one or more named entities in a piece of text, such as people (e.g., contributors and/or roles thereof), places, timelines, timespans, milestones, objectives, tasks, budgets, organizations, dates, etc. One or more embodiments can include performing sentiment analysis. The sentiment analysis can include analyzing the overall sentiment or emotional tone of a piece of text, such as whether it is positive, negative, or neutral. Finally, the results of the NLP process may be further refined using post-processing techniques such as entity co-reference resolution and/or disambiguation. In an exemplary embodiment of the present invention, the entity detection can extract keywords and/or meanings from text communication such as emails, instant messages, and meeting notes, as well as transcriptions of audio discussions, and identifies entities (e.g., project objectives, milestones, tasks, timelines, budgets, etc.) and determine sentiment towards the progress and/or likelihood of attaining identified entities. Based on the sentiment and the one or more detected entities associated therewith, project adjustments can be made accordingly.

In an embodiment of the present invention, the machine learning system 217 can further include an MLonCode (Machine Learning on Code) module 255. MLonCode (Machine Learning on Code) refers to the use of machine learning techniques to analyze and understand code. MLonCode aims to improve software development processes by automating various tasks such as code review, bug detection, code completion, and refactoring. MLonCode algorithms can be used to classify code according to, for example, its type, purpose, or functionality. This can be useful for organizing and searching code repositories, and for identifying patterns or trends in code usage. MLonCode algorithms can be used to detect bugs or errors in code by analyzing its syntax and structure. This can help developers to identify and fix bugs more quickly and efficiently. MLonCode can be used to analyze the effectiveness of source code for use in a project.

Ecosystem 201 may include email system 264 and/or instant message system 265. In an embodiment of the present invention, users may opt in to allow their text communication to be analyzed by machine learning system 217 generally, by user selection, by contributors, and/or according to detection of one or more predetermined entities. Ecosystem 201 may further include a code repository 261. The code repository 261 can include artifacts, such as source code files, configuration files, make files, build scripts, and so on. Additionally, the code repository 261 can include binary artifacts, such as executable programs, libraries, kernel modules, and so on. The code repository 261 can utilize a version control system 293 such as git, cvs, svn, or the like. The version control system 293 creates a record in the code repository 261 every time a new version of an artifact is supplied to the code repository. When a new version of an artifact is supplied, that can be referred to as ‘committing’ the artifact to the code repository 261.

Ecosystem 201 may further include project management data corpus 263. Project management data corpus 263 can include text, audio, video, and/or binary data pertaining to one or more projects. The projects can include metadata. The metadata can be used to sort and/or categorize projects (e.g., according to objectives, tasks, detected one or more entities, etc.). The projects referenced in the project management data corpus 263 can include ongoing projects, as well as previously completed projects. In an embodiment of the present inventive concept, previously completed projects that are similar to an imminent or ongoing (in progress) project may be automatically analyzed, and durations to achieve various milestones, deadlines, tasks, objectives, etc. can be compared with the ongoing project. As an example, a current project may plan for 3 days to obtain a particular certification from a testing authority. However, if previously completed projects that are similar in scope required four weeks to complete the certification, then it may be indicative of an unrealistic plan for the current project. In an embodiment of the present invention, these discrepancies can be identified through natural language processing, and an automatic project adjustment can be performed based on the risks, realistic plans, and/or discrepancies.

Ecosystem 201 may further include a continuous integration system 278. The continuous integration system 278 can include an automation server such as Jenkins, a code review tool, such as Gerrit, and may also integrate with the version control system 293. The continuous integration system 278 provides a platform for developers to automate the building, testing, and deployment of software applications. In an embodiment of the present invention, the number and/or rate of artifact commits, and/or the results of verification building and/or testing, can be used as criteria for performing a project adjustment. For example, if verification builds fail, or basic automated testing indicates failures at a rate above a predetermined threshold, then the software may be deemed unstable, and the project deadlines may be extended, and/or additional resources may be added to the project to help preserve the schedule for the project.

Ecosystem 201 may further include virtual environment system 267. The virtual environment system 267 can include one or more virtual machines for building, testing, and/or deploying software that is associated with a project. Virtual machine (VM) allocation involves the process of assigning virtualized computing resources to individual virtual machines within a virtualized environment. The allocation process can include various steps. In a virtualized environment, physical hardware resources such as CPU, memory, storage, and network capacity are pooled together. These resources are abstracted and made available for allocation to virtual machines. During the allocation process, administrators or users specify the desired resource allocation for each virtual machine. This includes defining the amount of CPU cores, memory, disk space, and network bandwidth required by the virtual machine. The virtualization platform's scheduling/orchestration algorithm determines the optimal placement of virtual machines on the available physical hosts. Criteria for virtual machine placement can include CPU and memory utilization, load balancing, affinity or anti-affinity rules, and high availability considerations. In one or more embodiments, the APAS 202 may interact with the virtual environment system 267 to allocate more virtual machines to a given project. For example, if data from the continuous integration system 278 indicates that software builds are taking longer than expected to complete because compile jobs are waiting in a queue for a virtual machine to become available, then exemplary embodiments of the present invention can increase the number of virtual machines within virtual environment system 267 that are allocated/assigned to a given project. In this way, the project can be proactively adjusted (e.g., in terms of resources and/or deadlines, etc.) to optimize the project development.

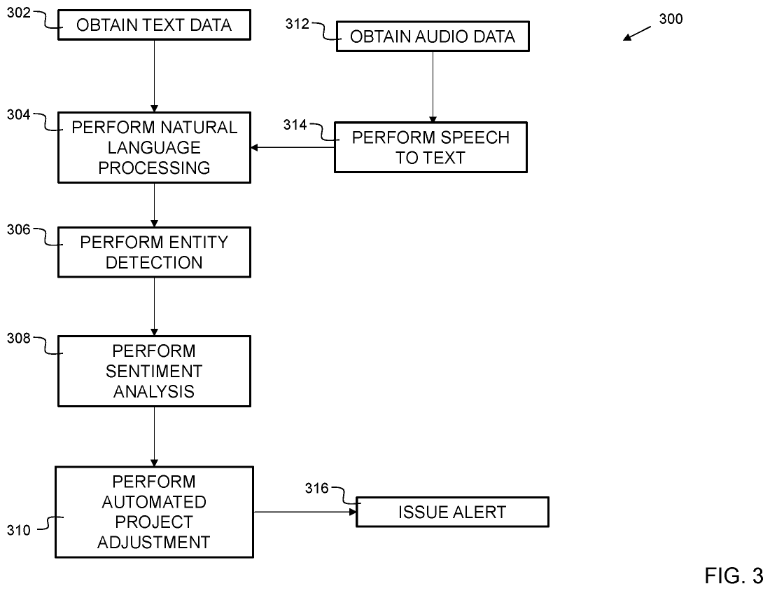

FIG. 3 illustrates a flowchart 300 indicating process steps in accordance with an exemplary embodiment of the present invention. At block 302, text data pertaining to a project can be obtained. The text data can include, but is not limited to, meeting notes, white papers, user stories, specifications, emails, instant messages, etc. In an embodiment of the present invention, the obtained text can include sentence prose. The sentence prose can include spoken and/or written language. The sentence prose can include transcriptions of live meetings, phone calls, web conferences, and/or teleconferences that are transcribed via a speech-to-text process.

At block 304, natural language processing can be performed. The natural language processing can include, but is not limited to, tokenization, indexing, concordance, entity detection, sentiment analysis, stop word processing, bigram processing, dispersion analysis, lexical richness analysis (ratio of distinct words to total words), disambiguation, part-of-speech analysis, and/or anaphora resolution (the process of identifying what a pronoun or noun phrase refers to).

At block 306, entity detection is performed on the obtained text data. Entity detection is a natural language processing (NLP) task that involves identifying and classifying named entities in text into predefined categories such as person names, organizations, locations, dates, and/or other entities, including project entities. In one or more embodiments, the entity detection can include detecting names of deliverable components of a project. The entity detection can include various steps, including, but not limited to, data preparation, linguistic feature extraction, and model training. In one or more embodiments, machine learning models such as conditional random fields (CRF), support vector machines (SVM), or neural networks like recurrent neural networks (RNNs) or transformers, are trained using the labeled training data and extracted features, enabling the trained models to recognize patterns that indicate different types of named entities. Once the model is trained, it can be used to predict entity labels for new, unseen text. The model analyzes the features of each word or token in the text and assigns it a label based on the learned patterns.

At block 308, sentiment analysis is performed. In one or more embodiments, the sentiment analysis is performed on communication pertinent to a project. The communication can include email, instant message, and/or other types of communication. Sentiment analysis can be used to determine a sentiment in a segment of text. The sentiment analysis can include performing text preprocessing. In the text preprocessing phase, the text is cleaned and prepared for analysis. This includes removing any irrelevant information, such as special characters or punctuation, normalizing the text by converting it to lowercase, and/or handling common language processing tasks like tokenization (splitting text into words or phrases) and stemming (reducing words to their root form). The sentiment can include a positive, neutral, or negative sentiment. The sentiment can be estimated using supervised machine learning techniques. This can include training a machine learning model on a labeled dataset, where each text sample is annotated with its corresponding sentiment. The model learns patterns and relationships between the text features and sentiment labels, enabling it to predict the sentiment of new, unseen text segments. Instead of, or in addition to, the machine learning, the sentiment analysis may further utilize heuristics via predefined lists of positive and negative words, along with linguistic rules, to determine sentiment based on the presence and context of these words in the text.

In addition to positive, negative, and neutral sentiments, exemplary embodiments of the present invention can also perform a confidence assessment, and based on the confidence assessment, can compute a confidence status. The confidence status can include a numerical score, indicative of a level of confidence in one or more text passages. In embodiments, the confidence status is a score ranging from 0 (not at all confident) to 100 (extremely confident). The score can be based on the number of qualifiers of low and/or high confidence detected in a text passage. The confidence status can be used by exemplary embodiments of the present invention as a criterion for determining if a project adjustment is warranted.

In one or more embodiments, the confidence assessment can include analyzing tone and language choice of communication such as emails and/or instant messages. Additionally, qualifiers can be identified and tabulated within text passages. The qualifiers represent words and/or phrases that indicate a level of uncertainty or lack of confidence. Examples include “possibly,” “maybe,” “potentially,” “it seems,” or using conditional language like “could,” “might,” or “would.” The presence of such language suggests a lower level of confidence. Similarly, qualifiers such as “I am certain that,” “I strongly believe,” or “without a doubt” convey high confidence, while phrases like “I'm not entirely sure,” “I think,” or “to the best of my knowledge” suggest lower confidence.

At block 310, an automated project adjustment is performed, based on the sentiment analysis performed at block 308. The automated project adjustment can include adjusting one or more deadlines, milestones, and/or other dates. For example, in response to determining a confidence status below a first predetermined threshold, a deadline can be extended by a first duration (e.g., 3 days), and in response to determining a confidence status below a second predetermined threshold, a deadline can be extended by a second duration (e.g., 5 days). Accordingly, the project deadlines are automatically adjusted based on sentiment in one or more embodiments. The automated project adjustment can include allocating one or more additional resources. The resources can include computing resources, such as additional virtual machines, networked storage, network bandwidth, and/or other computing resources. In one or more embodiments, the resources can include allocation of human resources, such as adding more engineers, technicians, testers, and/or other workers to a project. Accordingly, the project resources are automatically adjusted based on sentiment in one or more embodiments.

Optionally, at block 312 audio data is obtained. The audio data can include transcripts from phone calls, web conferences, live meetings, and so on. The audio data can be converted to text via a speech-to-text process at block 314. The speech-to-text process can include capturing audio input with a microphone to obtain an audio signal. In embodiments, the audio signal undergoes preprocessing steps to enhance its quality and make it more suitable for speech recognition. This may include noise reduction, normalization, and filtering. From the preprocessed audio, acoustic features are extracted. Exemplary embodiments of the present invention can include the use of Mel Frequency Cepstral Coefficients (MFCC), which represent the spectral characteristics of the speech signal over time. In one or more embodiments, machine-learning based acoustic models are trained to recognize patterns in the acoustic features and map them to corresponding phonemes or sub-word units. These models capture the relationship between audio signals and speech sounds. Additionally, machine-learning based language models are utilized to capture the statistical patterns and contextual information of the spoken language. They estimate the probability of word sequences and help constrain the output to improve recognition accuracy. Language models can be based on n-gram models, recurrent neural networks (RNNs), or transformer models. The acoustic and language models work together during the decoding phase to determine the most likely word sequence that matches the input speech. This process involves comparing the acoustic features with the acoustic model and combining it with the language model to generate the final text output, which is then input to the natural language processing at block 304, to perform a similar analysis as previously described for text data. Thus, exemplary embodiments of the present invention can utilize written and/or spoken communication as input for determining if an automatic project adjustment is warranted. Exemplary embodiments of the present invention can include obtaining audio data pertaining to the project, performing a speech-to-text process on the audio data to create transcribed text data, and performing an automated project adjustment at least partially based on the transcribed text data.

At block 316, an alert can be issued. The alert can include an electronic communication such as an email, instant message, text message, push notification, and so on to contributor(s) and/or other interested parties. In one or more embodiments, a distribution list of electronic addresses is established on the APAS 202, to enable dissemination of alerts on a project-by-project basis. The distribution list of electronic addresses can include electronic addresses corresponding to project stakeholders such as engineers, quality assurance personnel, managers, executives, and so on.

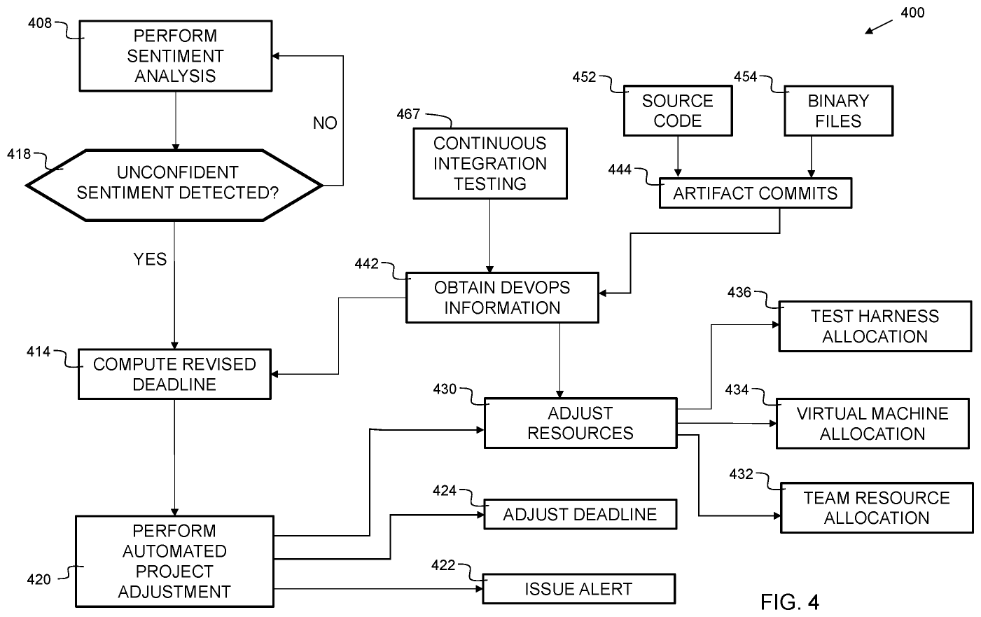

FIG. 4 illustrates a flowchart 400 indicating process steps for an exemplary embodiment of the present invention. At block 408 sentiment analysis can be performed on text data pertaining to the project, such as email communication, instant messages, notes, and meeting minutes. At block 418, a check is made to determine predetermined degrees of sentiment (e.g., unconfident sentiment). As described previously, the unconfident sentiment can be detected by natural language processing techniques, in accordance with exemplary embodiments of the present invention. In an embodiment, a numerical score for confidence can be computed based on the presence of qualifiers in the text. In response to determining an unconfident sentiment, the process can continue to block 414, and a revised deadline can be computed.

At block 420, an automated project adjustment can be performed. This can include updating deadlines in project data stored in project management data corpus 263. Additionally, other project information such as dashboards, Gantt charts, and other indicators can be revised accordingly, based on the updated project data that is provided as part of the automated project adjustment. Additionally, the automated project adjustment can include adjusting a deadline at block 424. In an embodiment, adjusting a deadline can be based on a level of confidence that is detected. As an example, in response to determining a slight unconfident sentiment, a deadline can be extended by five percent. Similarly, in response to determining a significant unconfident sentiment, a deadline can be extended by ten percent. The number of detected qualifiers in the analyzed text can be used as a criterion for determining the confidence level. If, at block 418, unconfident sentiment is not detected, then the process returns to block 408 to periodically/continuously perform sentiment analysis. In an embodiment, the automated project adjustment can include orchestration of robotic processes and/or provisioning and scheduling of human tasks, to decrease projected inefficiencies caused by wait time.

The automated project adjustment can include adjusting resources, at block 430. The adjusting of resources can include adjusting project resources such as virtual machine allocation at block 434. Virtual machine (VM) allocation involves the process of assigning virtualized computing resources to individual virtual machines within a virtualized environment. This can include resource pool creation, resource reservation, resource allocation, and scheduling and placement, among other functions. In one or more embodiments, to reduce the risk of a schedule slip for a project, additional physical hardware resources such as CPU, memory, storage, and network capacity are pooled together, and made available for allocation to support additional virtual machines for the project. The virtual machines can be used for compiling code, linking modules, deploying code, operating testing frameworks (test harnesses), and so on. By increasing the number of virtual machines, compile-deploy-test cycle time can be reduced, increasing the likelihood of a project meeting its deadlines.

The adjusting of resources can include adjusting project resources such as team resource allocation at block 432. In an embodiment, this can include analyzing the current team size, and interfacing with a work management system to automatically reassign workers to a project as part of an automated project adjustment. The adjusting of resources can include adjusting project resources such as test harness allocation at block 436. Test harness resources can be a bottleneck for progress on a project such as a software development project. The test harness, also known as a test framework or testing framework, is a set of tools, libraries, and utilities that provides a structured environment for automating and managing software testing activities. The test harness enables streamlining the process of test automation and facilitates the creation and execution of test cases. The test harness features can include test case management, test execution, test reporting and analysis, and so on. The test harness can be dependent on the type of software being developed for a given project. In one or more embodiments, the test harness can include JUnit for Java, NUnit for .NET, PyTest for Python, and Jasmine for JavaScript, and/or other suitable testing frameworks. In one or more embodiments, test harness allocation is accomplished by allocating more virtual machines, test hardware, network bandwidth, and/or other resources to the project.

The adjusting of resources can be based on obtaining DevOps information at block 442. DevOps is a set of practices that combines software development (Dev) and IT operations (Ops) to enhance collaboration and streamline the software delivery process. It focuses on breaking down silos between development and operations teams, promoting continuous integration, delivery, and deployment of software. The DevOps information can include continuous integration (CI) information. The information can include monitoring a rate of artifact commits to a code repository at block 444. The information can further include monitoring a rate of reverts of submissions to a code repository. Reverts can happen when submitted code is found to cause additional problems, causing the code change to be ‘undone.’ A high rate of reverts can be indicative of struggles in code development. In one or more embodiments, the rate of reverts can trigger an automated project adjustment. The commits can include source code at block 452. The source code can include code in Python, C, C++, Java, JavaScript, and/or other suitable programming language. The commits can include binary files at block 454. The binary files can include executable programs, libraries, device drivers, kernel modules, and/or other suitable binary files. In one or more embodiments, the DevOps information at block 442 can be used as criteria in computing a revised deadline at block 414. As an example, a low rate of artifact commits (e.g., less than 5 per day), can be indicative of reduced progress, causing a deadline to be recomputed and extended, based on the reduced amount of developer activity, as determined by the low number of artifact commits. The DevOps information can include results from continuous integration testing at block 467. The continuous integration testing can include automated tests, including basic functionality tests, network accessibility tests, software upgrade/downgrade tests, and so on. A high failure rate in the continuous integration testing can be a criterion for an automated project adjustment such as revising project deadlines and/or adjusting project resources.

At block 422 an alert can be issued. The alert can include an electronic communication such as an email, instant message, text message, push notification, and so on. In one or more embodiments, a distribution list of electronic addresses is established on the APAS 202 (FIG. 2), to enable dissemination of alerts on a project-by-project basis. The distribution list of electronic addresses can include electronic addresses corresponding to project stakeholders such as engineers, quality assurance personnel, managers, executives, and so on. The alert can indicate which type(s) of automated project adjustments have been performed. In an embodiment, a user (e.g., contributor, project manager, or other interested party) has the option to accept or decline an automated project adjustment. In this way, the project team can retain full control, while utilizing the features of exemplary embodiments of the present invention to make decisions in real-time, based on project information such as communication between team members, artifact submission rates, DevOps information, and/or other relevant information.

In an exemplary embodiment, performing the automated project adjustment can include performing a project resource adjustment. In an exemplary embodiment, performing the automated project adjustment includes performing a project deadline adjustment. An exemplary embodiment can include obtaining DevOps information. The project resource adjustment can be based on the DevOps information. An exemplary embodiment can include obtaining DevOps information. The project deadline adjustment can be based on the DevOps information. In an exemplary embodiment, the DevOps operation can include a predetermined amount of artifact commits. In an embodiment, the artifact commits can include at least one of source code files and binary files. In an exemplary embodiment, the DevOps information can include a result of continuous integration testing.

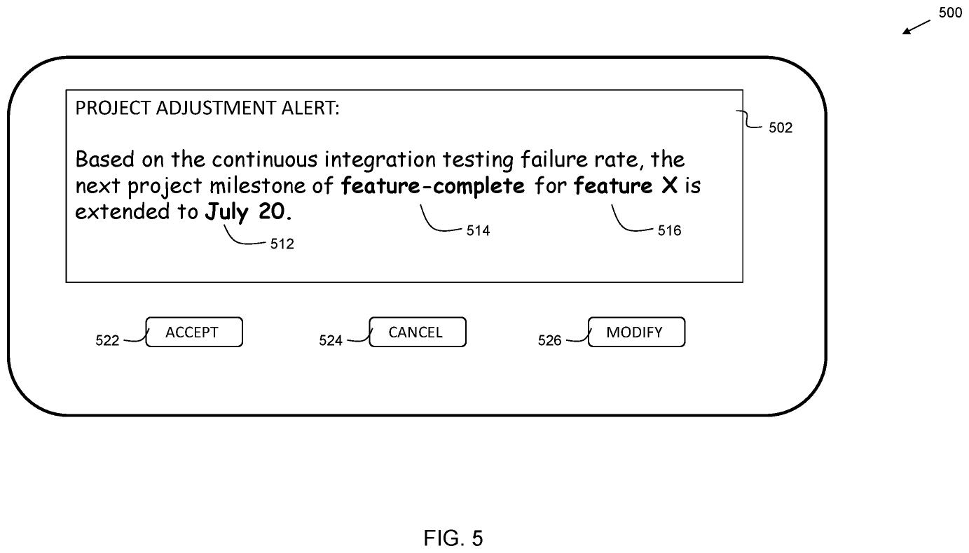

FIG. 5 illustrates an exemplary user interface 500 in accordance with embodiments of the present invention. User interface 500 shows an example of a project adjustment alert at field 502. The alert can include a project milestone 514, a feature 516, and a deadline adjustment date 512. The deadline can be a deadline for the entire project, and/or a specific portion of a project. The user interface 500 includes an accept button 522. Invoking the accept button 522 causes the APAS 202 to perform the project adjustments, updating information in the project management data corpus 263 (FIG. 2) and/or other databases and/or project management systems. The user interface 500 includes a cancel button 524. Invoking the cancel button 524 causes the APAS 202 (FIG. 2) to discard the project adjustment, and as a result, no changes to the project deadlines/resources are made. The user interface 500 includes a modify button 526. Invoking the modify button 526 causes the APAS 202 (FIG. 2) to enable a user to edit project adjustment parameters. As an example, a user can modify the adjustment date 512 from July 20 to July 27 if the user deems that to be a more appropriate adjustment date. In an embodiment, the project adjustments are automatically applied without the need for user intervention. In such embodiments, a project adjustment alert can provide an option to undo the automatic project adjustment, if the user (e.g., project manager) deems it appropriate to do so. Embodiments can include issuing a project adjustment alert based on the automated project adjustment.

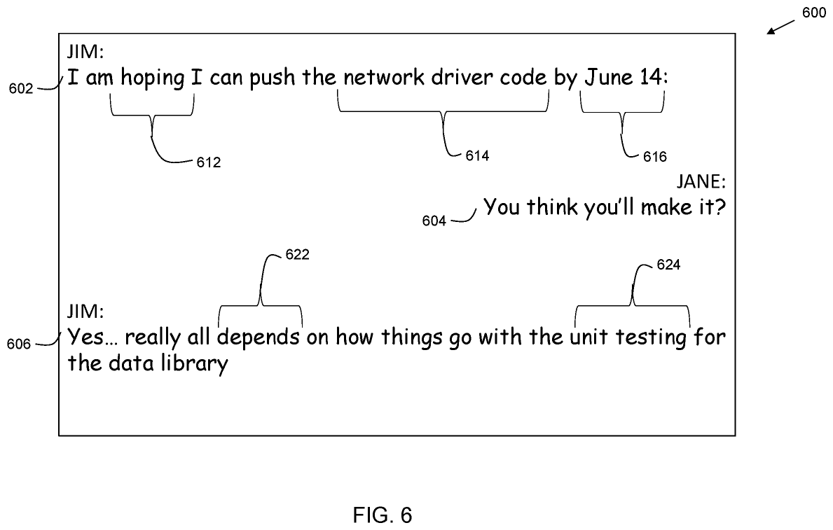

FIG. 6 illustrates an example 600 showing exemplary text data pertaining to a project, analyzed in accordance with an exemplary embodiment of the present invention. Line 602 represents a line of text communication on an instant messaging platform from a first user. Line 604 represents a line of text communication on an instant messaging platform from a second user. Line 606 represents another line of text communication on an instant messaging platform from the first user. Words and/or phrases can be identified as qualifiers for confidence analysis via semantics and/or machine learning techniques such as natural language processing. Examples of qualifiers are indicated at 612 with the word ‘hoping’ and at 622 with the word ‘depends.’ These qualifiers can be used to assess confidence pertaining to entities detected by an entity detection process. In the example 600, entities include ‘network driver code’ at 614, the date of June 14, at 616, and ‘unit testing’ at 624. In disclosed embodiments, a level of confidence for a deliverable can be computed, and an automated project adjustment can be performed based on the level of confidence. In the example 600, the deliverable of the network driver code at 614 may be deemed to be at risk of missing the deadline of June 14 at 616, based on the qualifier of ‘hoping’ at 612, which indicates reduced confidence that the deadline will be met.

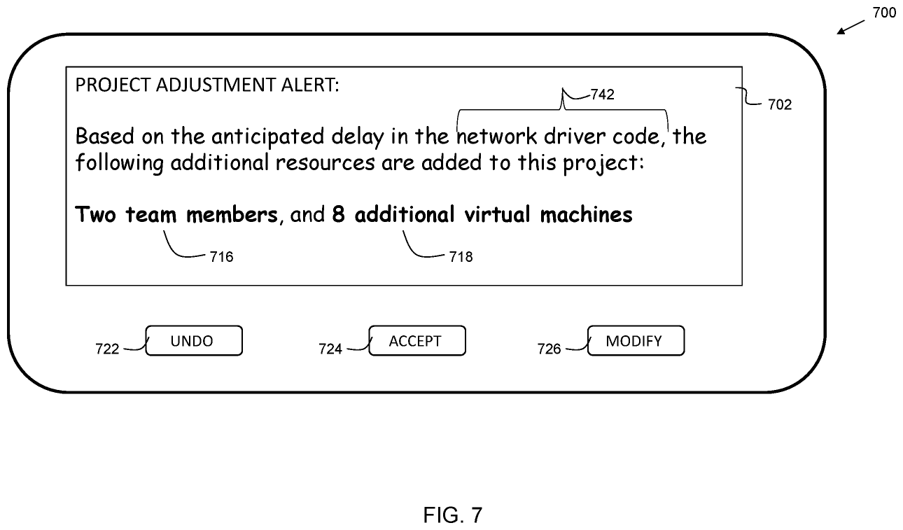

FIG. 7 illustrates another exemplary user interface 700 in accordance with an exemplary embodiment of the present invention. User interface 700 shows an example of a project adjustment alert at field 702. The alert can include a feature 742, and corresponding resource adjustments indicated of two team members indicated at 716, and eight additional virtual machines, indicated at 718. The user interface 700 includes an undo button 722. Invoking the undo button 722 causes the APAS 202 to undo the automated project adjustments, updating information in the project management data corpus 263 (FIG. 2) and/or other databases and/or project management systems as appropriate. The user interface 700 includes an accept button 724. Invoking the accept button 724 closes the user interface 700, accepting the automatic project adjustment changes. The user interface 700 includes a modify button 726. Invoking the modify button 726 causes the APAS 202 (FIG. 2) to enable a user to edit project adjustment parameters. As an example, a user can modify the number of additional virtual machines from eight to ten, if the user deems that to be a more appropriate allocation of virtual machines.

As can now be appreciated, disclosed embodiments provide improvements in the technical field of project management. By utilizing NLP, entity detection, and sentiment analysis, automated project adjustments, including deadline adjustments and/or resource adjustments can be made to help projects stay on track. The sentiment analysis can include a confidence measurement. Often people within organizations approach similar opportunities or obstacles without knowing that someone else has previously gone through a similar experience. If a solution has been proposed that has potential risks or barriers, they often result in repeating these same mistakes and blockers, as they were not aware of the issues during the solution planning phase of the project. Disclosed embodiments provide proactive techniques based on previous project history, as well as a confidence measurement of project-based communication, to inform users of potential risks to project schedules.

A hypothetical use case for disclosed embodiments can include a project such as planning for a proof-of-concept demonstration. Information from various collaboration tools such as Slack™, Box™, Trello™, MS Teams™, Salesforce™, GitHub, and/or other productivity tools, can be obtained. Project criteria can be obtained via the collaboration tools, and identified via entity detection. The entities can include, but are not limited to, a number of employees participating, a number of resources available, a list of required approvals, and/or other project prerequisites. Disclosed embodiments utilize the information obtained via the natural language processing, and analyze the information by comparing it with similar projects stored within the project management data corpus 263. As an example, the current project may have deadlines that include allocating one week for security clearances. However, disclosed embodiments may determine, based on similar projects stored within the project management data corpus 263, that security clearances for a project of this scope have previously required four to six weeks. In this example, an automated project adjustment can be performed, and/or a project alert issued, to alert stakeholders of the identified risks and potential blockers for completion of the project, potentially saving considerable cost and time. Thus, disclosed embodiments provide proactive to inform users of potential risks to project schedules.

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

What is claimed is:

1. A computer-implemented method, comprising:
obtaining text data pertaining to a project;
performing natural language processing (NLP) on the obtained text data, wherein the NLP includes detecting one or more entities;
performing sentiment analysis associated with the detected one or more entities; and
performing an automated project adjustment based on the performed sentiment analysis and the detected one or more entities.

2. The method of claim 1, wherein the performing of the automated project adjustment includes performing a project resource adjustment.

3. The method of claim 1, wherein the performing of the automated project adjustment includes performing a project deadline adjustment.

4. The method of claim 1, further comprising:
obtaining audio data pertaining to the project; and
performing a speech-to-text process on the obtained audio data to create transcribed text data, wherein performing the automated project adjustment is further based on the transcribed text data.

5. The method of claim 2, further comprising:
obtaining DevOps information, wherein the project resource adjustment is based on the obtained DevOps information.

6. The method of claim 3, further comprising:
obtaining DevOps information, wherein the project deadline adjustment is based on the obtained DevOps information.

7. The method of claim 6, wherein the obtained DevOps information includes artifact commits.

8. The method of claim 7, wherein the artifact commits include at least one of source code files and binary files.

9. The method of claim 6, wherein the obtained DevOps information includes a result of continuous integration testing.

10. The method of claim 1, further comprising:
issuing a project adjustment alert based on the performed automated project adjustment.

11. A computer system comprising:
at least one computer processor, at least one computer-readable storage media, and program instructions stored on the at least one of the computer-readable storage media for execution by at least one of the at least one processor capable of performing a method, the method comprising:
obtaining text data pertaining to a project;
performing natural language processing (NLP) on the obtained text data, wherein the NLP includes detecting at least one entity;
performing sentiment analysis associated with the detected at least one entity; and
performing an automated project adjustment based on the performed sentiment analysis and the detected at least one entity.

12. The computer system of claim 11, wherein the performing of the automated project adjustment includes performing a project resource adjustment.

13. The computer system of claim 11, wherein the performing of the automated project adjustment includes performing a project deadline adjustment.

14. The computer system of claim 11, the method further comprising:
obtaining audio data pertaining to the project; and
performing a speech-to-text process on the audio data to create transcribed text data, wherein performing the automated project adjustment is further based on the transcribed text data.

15. The computer system of claim 12, the method further comprising:
obtaining DevOps information, wherein the project resource adjustment is based on the DevOps information.

16. The computer system of claim 13, the method further comprising:
obtaining DevOps information, wherein the project deadline adjustment is based on the DevOps information.

17. A computer program product comprising:
at least one computer-readable storage media and program instructions stored on the at least one non-transitory computer-readable storage media capable of performing a method, the method comprising:
obtaining text data pertaining to a project;
performing natural language processing (NLP) on the obtained text data, wherein the NLP includes detecting at least one entity;
performing sentiment analysis associated with the detected at least one entity; and
performing an automated project adjustment based on the performed sentiment analysis and the detected at least one entity.

18. The computer program product of claim 17, wherein the performing of the automated project adjustment includes performing a project resource adjustment.

19. The computer program product of claim 17, wherein the performing of the automated project adjustment includes performing a project deadline adjustment.

20. The computer system of claim 17, the method further comprising:
obtaining audio data pertaining to the project; and
performing a speech-to-text process on the audio data to create transcribed text data, wherein performing the automated project adjustment is further based on the transcribed text data.
